(19) United States
(12) Patent Application Publication
(10) Pub. No.: US 2021/0196433 A1
(43) Pub. Date: Jul. 1, 2021

(54) Orthodontic Device

(71) Applicant: Gerald Spencer, Sedalia, MO (US)

(72) Inventor: Gerald Spencer, Sedalia, MO (US)

(21) Appl. No.: 16/730,044

(22) Filed: Dec. 30, 2019

(51) Int. Cl. A61C 7/36

(52) U.S. Cl. CPC A61C 7/36

(57) ABSTRACT

An orthodontic device for correcting malocclusions and asymmetries includes a set of first elements and a set of second elements. Each first element is coupled to at least one of a lower tooth of a user and an orthodontic appliance positioned on the lower tooth. Each second element is coupled to at least one of an upper tooth of the user and an orthodontic appliance positioned on the upper tooth. The second element is positioned on the upper tooth so that the second element is positioned to contact an associated first element as jaws of the user are closed. The second element and the associated first element are configured to exert a force upon a mandible of the user to correct at least one of a malocclusion and an asymmetry.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to orthodontic devices and more particularly pertains to a new orthodontic device for correcting malocclusions and asymmetries.

### (2) Description of Related Art Including Information Disclosed Under 37 CFR 1.97 and 1.98

The prior art relates to orthodontic devices for correcting malocclusions and asymmetries. Prior art devices generally comprise elements, such as springs and elastomeric bands, which are coupled to and extend between one or more upper teeth and one or more lower teeth to exert a corrective force on the mandible.

### BRIEF SUMMARY OF THE INVENTION

An embodiment of the disclosure meets the needs presented above by generally comprising a set of first elements and a set of second elements. Each first element is coupled to at least one of a lower tooth of a user and an orthodontic appliance positioned on the lower tooth. Each second element is coupled to at least one of an upper tooth of the user and an orthodontic appliance positioned on the upper tooth. The second element is positioned on the upper tooth so that the second element is positioned to contact an associated first element as jaws of the user are closed. The second element and the associated first element are configured to exert a force upon a mandible of the user to correct at least one of a malocclusion and an asymmetry.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of an orthodontic device according to an embodiment of the disclosure.

FIG. 2 is an isometric perspective view of an embodiment of the disclosure.

FIG. 3 is an in-use view of an embodiment of the disclosure.

FIG. 4 is an in-use view of an embodiment of the disclosure.

FIG. 5 is an in-use view of an embodiment of the disclosure.

FIG. 6 is an in-use view of an embodiment of the disclosure.

FIG. 7 is an in-use view of an embodiment of the disclosure.

FIG. 8 is an isometric perspective view of an alternative embodiment of the disclosure.

FIG. 9 is an isometric perspective view of an alternative embodiment of the disclosure.

FIG. 10 is an in-use view of an alternative embodiment of the disclosure.

FIG. 11 is an in-use view of an alternative embodiment of the disclosure.

FIG. 12 is an in-use view of an alternative embodiment of the disclosure.

FIG. 13 is an in-use view of an alternative embodiment of the disclosure.

### DETAILED DESCRIPTION OF THE INVENTION

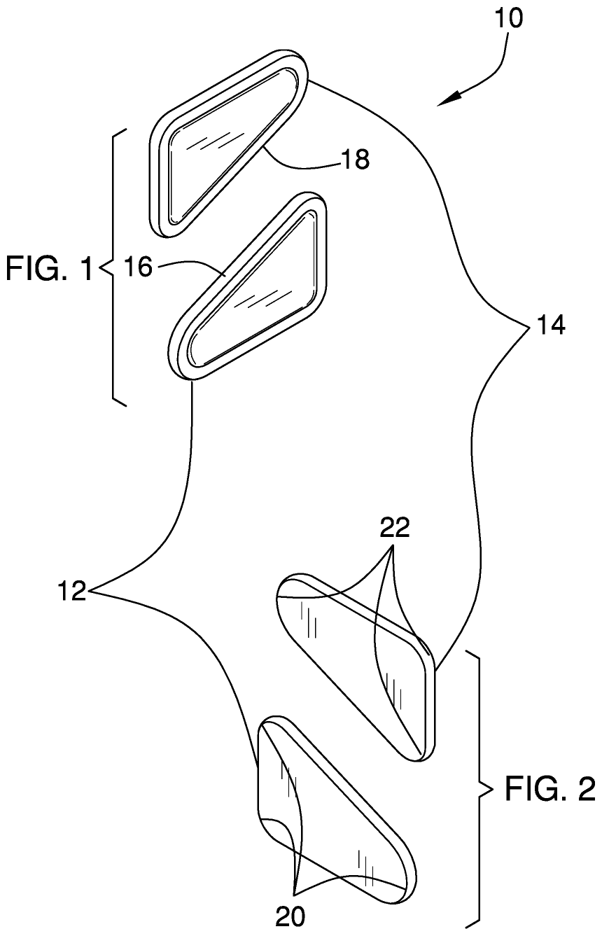

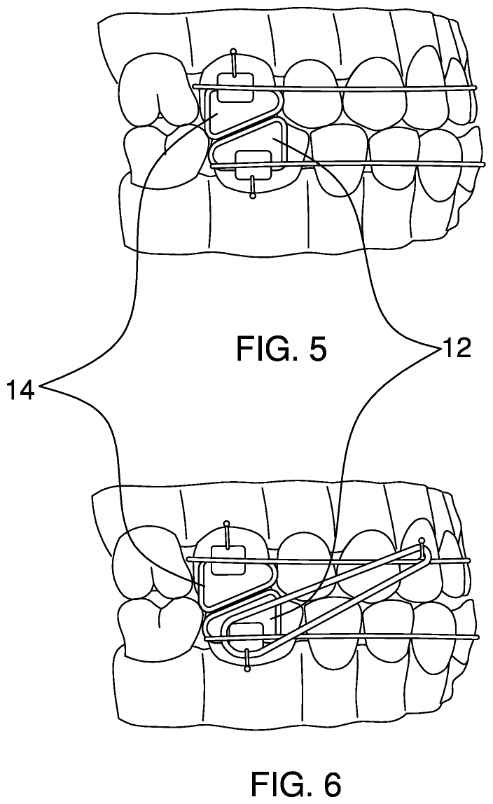

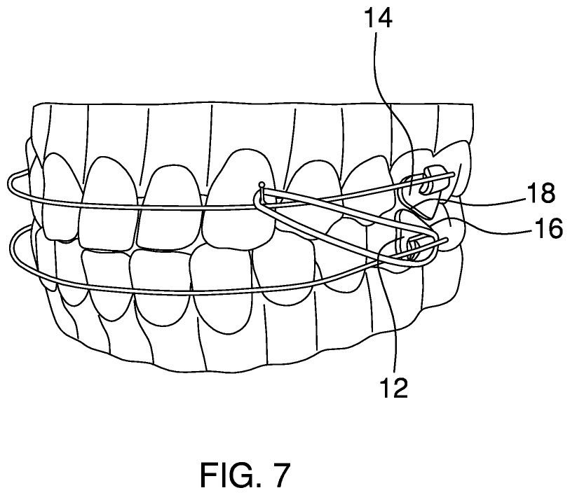

With reference now to the drawings, and in particular to FIGS. 1 through 13 thereof, a new orthodontic device embodying the principles and concepts of an embodiment of the disclosure and generally designated by the reference numeral 10 will be described.

As best illustrated in FIGS. 1 through 13, the orthodontic device 10 generally comprises a set of first elements 12 and a set of second elements 14. Each first element 12 is coupled to at least one of a lower tooth of a user and an orthodontic appliance that is positioned on the lower tooth.

Each second element 14 is coupled to at least one of an upper tooth of the user and an orthodontic appliance that is positioned on the upper tooth. The second element 14 is positioned on the upper tooth so that the second element 14 is positioned to contact an associated first element 12 as jaws of the user are closed. The second element 14 and the associated first element 12 are configured to exert a force upon a mandible of the user to correct at least one of a malocclusion and an asymmetry.

The associated first element 12 may be adhesively coupled at least one of the lower tooth of the user and the orthodontic appliance that is positioned on the lower tooth of the user. The second element 14 may be adhesively coupled at least one of the upper tooth of the user and the orthodontic appliance that is positioned on the upper tooth of the user.

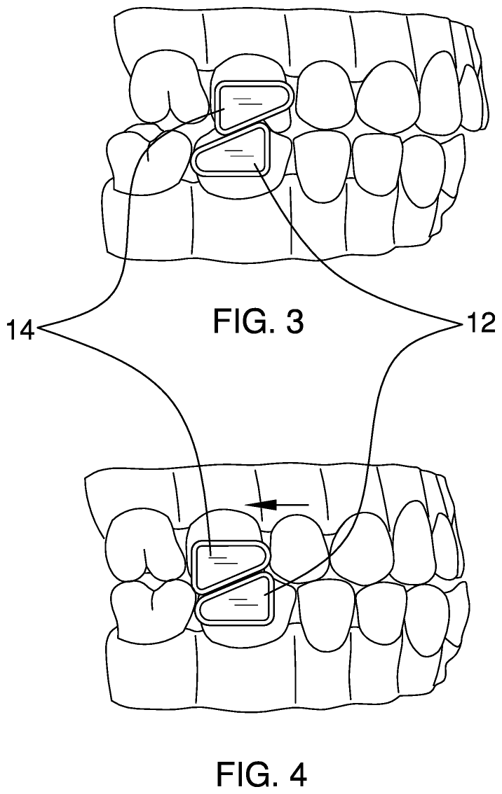

By way of a first nonlimiting example, depicted in FIGS. 3 and 4, the associated first element 12 and the second element 14 are coupled to the lower tooth and the upper tooth, respectively. By way of a second nonlimiting example, as shown in FIGS. 5-7, the associated first element 12 is adhesively coupled to both the lower tooth and the orthodontic appliance that is positioned on the lower tooth. Also, in the second nonlimiting example, the second element 14 is adhesively coupled to both the upper tooth and the orthodontic appliance that is positioned on the upper tooth.

The present invention also anticipates the associated first element 12 and the second element 14 being integral to a pair of clear aligners that are positioned singly over lower teeth and upper teeth of the user, respectively.

The associated first element 12 is at least one of triangularly shaped, trapezoidally shaped, rectangularly shaped, squarely shaped, circularly shaped, and ovally shaped. The second element 14 also is at least one of triangularly shaped, trapezoidally shaped, rectangularly shaped, squarely shaped, circularly shaped, and ovally shaped.

In one embodiment, as shown in FIGS. 1-7, the associated first element 12 and the second element 14 both are triangularly shaped so that an occlusive surface 16 of the associated first element 12 and an occlusive face 18 of the second element 14 extend angularly from proximate to a mesial surface to proximate to a distal surface of the lower tooth and the upper tooth, respectively. The occlusive surface 16 of the second element 14 is positioned to slide along the occlusive face 18 of the associated first element 12 as the jaws of the user are closed. The second element 14 and the associated first element 12 thus are configured to exert the force upon the mandible to correct the at least one of the malocclusion and the asymmetry.

The associated first element 12 has first vertices 20 and the second element 14 has second vertices 22. The first vertices 20 and the second vertices 22 are arcuate to enhance comfort of the user.

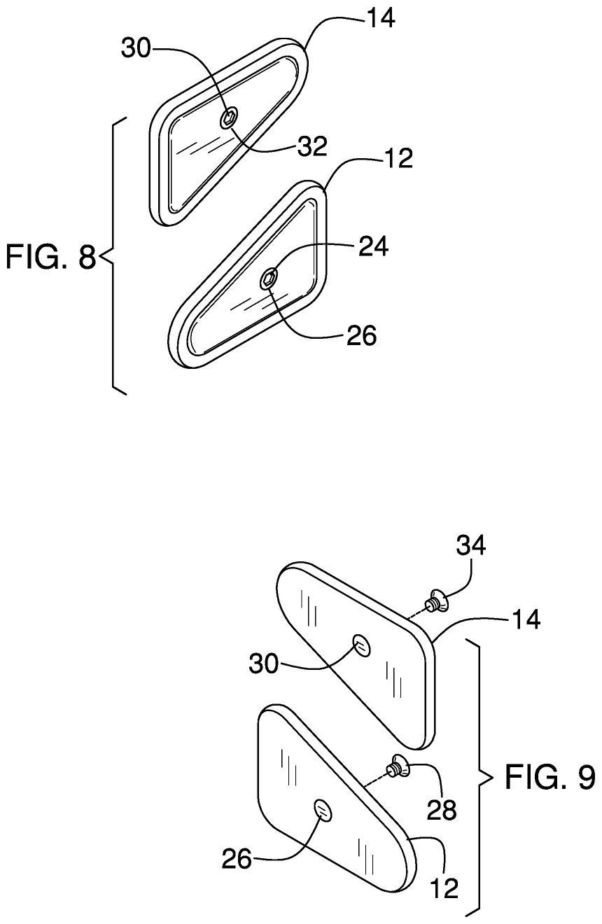

In addition to adhesive coupling of the associated first element 12 and the second element 14 to the lower tooth and the upper tooth, respectively, the present invention anticipates other coupling means, such as, but not limited to, wires, socket and screw combinations, as shown in FIGS. 8 and 9 and described in detail below, and the like.

In another embodiment, as shown in FIGS. 8 and 9, a first socket 24 is coupled to the lower tooth and extends into a first channel 26 that is positioned through the associated first element 12 so that the associated first element 12 is selectively rotatable around the first socket 24. The first socket 24 is internally threaded so that a first screw 28, which is complementary to the first socket 24, is threadedly insertable into the first socket 24 to selectively fixedly position the associated first element 12 relative to the lower tooth.

A second socket 30 is coupled to the upper tooth and extends into a second channel 32 that is positioned through the second element 14 so that the second element 14 is selectively rotatable around the second socket 30. The second socket 30 is internally threaded. A second screw 34, which is complementary to the second socket 30, is threadedly insertable into the second socket 30 to selectively fixedly position the second element 14 relative to the upper tooth. The associated first element 12 and the second element 14 being selectively rotatable relative to the lower tooth and the upper tooth, respectively, and then being selectively fixedly positionable allows for adjustment of angulation of contact between the occlusive surface 16 and the occlusive face 18.

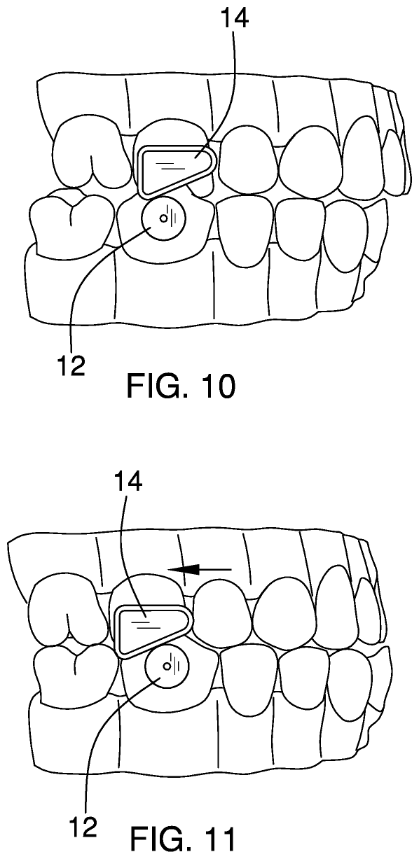

In yet another embodiment, as shown in FIGS. 10 and 11, the associated first element 12 is circularly shaped and is rotationally coupled to the lower tooth. The second element 14 is triangularly shaped so that the occlusive face 18 of the second element 14 extends angularly from proximate to the mesial surface to proximate to the distal surface of the upper tooth. The associated first element 12 is positioned to roll along the occlusive face 18 of the second element 14 as the jaw of the user is closed. The second element 14 and the associated first element 12 are configured to exert the force upon the mandible to correct the at least one of the malocclusion and the asymmetry.

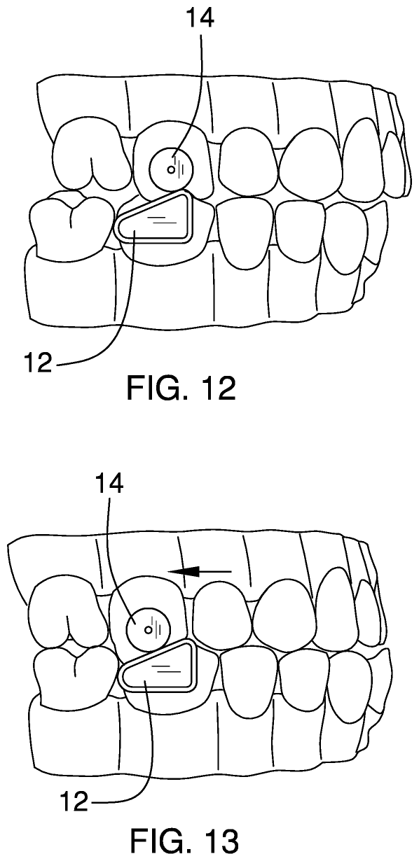

In still yet another embodiment, as shown in FIGS. 12 and 13, the second element 14 is circularly shaped and is rotationally coupled to the upper tooth. The associated first element 12 is triangularly shaped so that the occlusive surface 16 of the associated first element 12 extends angularly from proximate to the mesial surface to proximate to the distal surface of the lower tooth. The second element 14 is positioned to roll along the occlusive surface 16 of the associated first element 12 as the jaw of the user is closed. The associated first element 12 and the second element 14 are configured to exert the force upon the mandible to correct the at least one of the malocclusion and the asymmetry.

In one example of use, first elements 12 are attached singly to the lower first molars of the user and second elements 14 are attached singly to the upper first molars of the user. As the jaw of the user is closed, the occlusive surface 16 of the second element 14 is positioned to slide along the occlusive face 18 of the associated first element 12. The second element 14 and the associated first element 12 thus are configured to exert the force upon the mandible to correct the at least one of the malocclusion and the asymmetry.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An orthodontic device comprising:
a set of first elements, each first element being configured to be coupled to at least one of a lower tooth of a user and an orthodontic appliance positioned on the lower tooth;
a set of second elements, each second element being configured to be coupled to at least one of an upper tooth of the user and an orthodontic appliance positioned on the upper tooth, each second element being configured to be positioned on the upper tooth such that the second element is positioned for contacting an associated one of said first elements as jaws of the user are closed wherein the second element and the associated one of said first elements are configured for exerting a force upon a mandible of the user for correcting at least one of a malocclusion and an asymmetry;
the associated first element being triangularly shaped such that an occlusive surface of the associated first element extends angularly from proximate to a mesial surface to proximate to a distal surface of the lower tooth; and
the second element being triangularly shaped such that an occlusive face of the second element extends angularly from proximate to a mesial surface to proximate to a distal surface of the upper tooth such that the occlusive surface of the second element is positioned for sliding along the occlusive face of the associated first element wherein the second element and the associated first element are configured for exerting the force upon the mandible for correcting the at least one of the malocclusion and the asymmetry.

2. The device of claim 1, further comprising:
the associated first element being adhesively coupled at least one of the lower tooth of the user and the orthodontic appliance positioned on the lower tooth of the user; and
the second element being adhesively coupled at least one of the upper tooth of the user and the orthodontic appliance positioned on the upper tooth of the user.

3. (canceled)

4. (canceled)

5. The device of claim 1, further comprising:
a first socket coupled to the lower tooth and extending into a first channel positioned through the associated first element such that the associated first element is selectively rotatable around the first socket, the first socket being internally threaded;
a first screw complementary to the first socket such that the first screw is threadedly insertable into the first socket for selectively fixedly positioning the associated first element relative to the lower tooth;
a second socket coupled to the upper tooth and extending into a second channel positioned through the second element such that the second element is selectively rotatable around the second socket, the second socket being internally threaded; and
a second screw complementary to the second socket such that the second screw is threadedly insertable into the second socket for selectively fixedly positioning the second element relative to the upper tooth.

6. The device of claim 1, further comprising:
the associated first element having first vertices, the first vertices being arcuate; and
the second element having second vertices, the second vertices being arcuate.

7. (canceled)

8. (canceled)

9. An orthodontic device comprising:
a set of first elements, each first element being coupled to at least one of a lower tooth of a user and a orthodontic appliance positioned on the lower tooth, the first element being adhesively coupled at least one of the lower tooth of the user and the orthodontic appliance positioned on the lower tooth of the user, the first element being at least one of triangularly shaped, trapezoidally shaped, rectangularly shaped, squarely shaped, circularly shaped, and ovally shaped, the first element being triangularly shaped such that an occlusive surface of the first element extends angularly from proximate to a mesial surface to proximate to a distal surface of the lower tooth, the first element having first vertices, the first vertices being arcuate;
a set of second elements, each second element being coupled to at least one of an upper tooth of the user and an orthodontic appliance positioned on the upper tooth, the second element being positioned on the upper tooth such that the second element is positioned for contacting an associated first element as jaws of the user are closed wherein the second element and the associated first element are configured for exerting a force upon a mandible of the user for correcting at least one of a malocclusion and an asymmetry, the second element being adhesively coupled at least one of the upper tooth of the user and the orthodontic appliance positioned on the upper tooth of the user, the second element being at least one of triangularly shaped, trapezoidally shaped, rectangularly shaped, squarely shaped, circularly shaped, and ovally shaped, the second element being triangularly shaped such that an occlusive face of the second element extends angularly from proximate to a mesial surface to proximate to a distal surface of the upper tooth such that the occlusive surface of the second element is positioned for sliding along the occlusive face of the associated first element wherein the second element and the associated first element are configured for exerting the force upon the mandible for correcting the at least one of the malocclusion and the asymmetry, the second element having second vertices, the second vertices being arcuate;
a first socket coupled to the lower tooth and extending into a first channel positioned through the associated first element such that the associated first element is selectively rotatable around the first socket, the first socket being internally threaded;
a first screw complementary to the first socket such that the first screw is threadedly insertable into the first socket for selectively fixedly positioning the associated first element relative to the lower tooth;
a second socket coupled to the upper tooth and extending into a second channel positioned through the second element such that the second element is selectively rotatable around the second socket, the second socket being internally threaded; and
a second screw complementary to the second socket such that the second screw is threadedly insertable into the second socket for selectively fixedly positioning the second element relative to the upper tooth.
